(19) United States
(12) Patent Application Publication
(10) Pub. No.: US 2013/0325536 A1
(43) Pub. Date: Dec. 5, 2013

(54) MEASURING SHORT-TERM COGNITIVE APTITUDES OF WORKERS FOR USE IN RECOMMENDING SPECIFIC TASKS

(71) Applicants: Mark E. Podlaseck, Kent, CT (US); Larisa Shwartz, Scarsdale, NY (US)

(72) Inventors: Mark E. Podlaseck, Kent, CT (US); Larisa Shwartz, Scarsdale, NY (US)

(73) Assignee: INTERNATIONAL BUSINESS MACHINES CORPORATION, Armonk, NY (US)

(21) Appl. No.: 13/483,887

(22) Filed: May 30, 2012

(51) Int. Cl. G06Q 10/06

(52) U.S. Cl. 705/7.14

(57) ABSTRACT

In a method for selecting a worker to whom to suggest a task, a set of workers is selected initially, each having LCS and RSC values derived from prior performances of the task. A game score is acquired for each worker, wherein each game score is a measurement of the level of a cognitive aptitude which is needed to perform the task. A given worker of the initial set is placed into a task performance candidate set, only if the game score of the given worker is no less than the LCS of the given worker. The method further comprises selectively processing data provided collectively by the LCS and the RSC of each worker in the candidate set, in order to select one of the workers in the candidate set to whom to recommend the specified task.

### BACKGROUND

1. Field

The invention disclosed and claimed herein generally pertains to a method and system for measuring one or more cognitive aptitudes of each worker of a group of workers. More particularly, the invention pertains to a method and system of the above type, wherein the measurements are used to help workers to select the tasks for which they demonstrate the most cognitive affinity.

2. Description of the Related Art

Cognitive capability, or cognition, refers to mental processes that can include skills such as attention, remembering, producing and understanding language, solving problems, and making decisions. At present, workflow processes typically assume that a worker or employee possesses a fixed cognitive capability. However, the cognitive state of a person can vary significantly from day to day, and also during a single day. For example, an individual could be very alert before lunch, and then afterward be in a state of post-prandial somnolence, or drowsiness. As another example, the stress of an emergency could cause the attention of one person to become focused, while causing another person to become very distracted. An unpleasant exchange between members of a work group could impede an imminent collaboration, whereas a cordial or complimentary comment from one group member to another could enhance collaboration.

As a result of events of the type described above, as well as the occurrence of fatigue or other events that affect the emotional state or stress level of a worker, the ability of the worker to notice details, solve problems, and remember new information can change frequently. Accordingly, the ability of a worker to perform a task which requires any of these cognitive skills can likewise be in a state of continual change. The worker may thus be able to perform a particular task very well at one time, but not at another time. Clearly, this situation presents a challenge to the management of workflow, wherein the workflow includes tasks requiring cognitive skills such as those described above.

### SUMMARY

Embodiments of the invention pertain to a method, system and computer program product that can be used in a work environment or the like, wherein a worker chooses a task to perform from a number of tasks that need to be done. Moreover, task performance will require a specific set of cognitive skills or aptitudes. Accordingly, it would be desirable for a worker who possesses a set of skills or aptitudes to a significant degree, at the time when a task is to be carried out, to be made aware which tasks are best suited to him or her at that moment. To achieve this in embodiments of the invention, each worker in the group is initially directed to play or engage in a game or like activity, wherein success in the game requires a specific cognitive aptitude that is also needed for successful completion of the task. Thus, the game scores received by respective workers measure the aptitude that each worker then has for the specified task. After game scores have been acquired for each worker of the group, the scores will be collectively used to determine which worker the task will be recommended to.

In one embodiment, comprising a method for recommending tasks to a worker to perform a specified task, an initial set of workers is selected, wherein each worker has a least score value and an associated score cardinality, which are respectively derived from one or more prior performances of the specified task by the given worker. The method further includes acquiring a game score from each worker of the initial set, wherein the game score of a given worker is a measurement of the level of a cognitive aptitude which the given worker possesses, and the cognitive aptitude is needed to perform the specified task. One or more of the workers of the initial set is placed into a task performance candidate set, wherein a given worker is placed into the candidate set only if the game score of the given worker is no less than the least score value of the given worker. The method further comprises selectively processing data provided collectively by the least score value and the score cardinality of each worker in the candidate set, to recommend tasks to specific workers.

### BRIEF DESCRIPTION OF THE SEVERAL VIEWS OF THE DRAWINGS

FIG. 1 is a schematic diagram showing steps for a method comprising an embodiment of the invention.

FIG. 2 is a flowchart showing an algorithm that may be used to implement steps of the embodiment of FIG. 1.

FIG. 3 is a flowchart showing an algorithm that may be used to further implement one or more steps of the embodiment of FIG. 1.

FIG. 4 is a flowchart showing steps for a further embodiment of the invention.

FIG. 5 is a block diagram showing a computer or data processing system that may be used in implementing embodiments of the invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

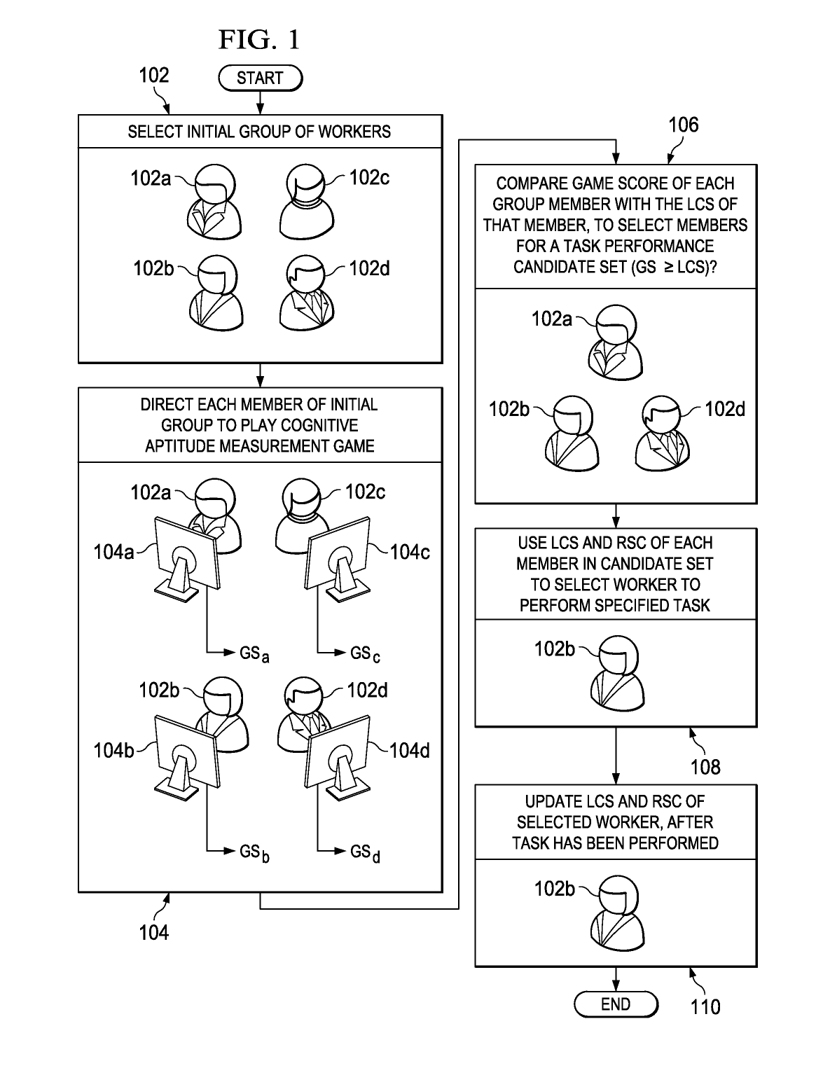

Referring to FIG. 1, there is shown a schematic diagram depicting panels 102-110, each associated with a step or action for a method comprising an embodiment of the invention. The method of FIG. 1 is commenced or started when a specified task is received at a work environment, such as an IT work environment. The specified task, in order to be performed successfully, should be carried out by one who possesses a high degree of a particular cognitive aptitude or skill, at the time of performance. For purposes of illustration, the particular cognitive aptitude could be the ability to notice details, to solve problems, to collaborate, or to remember new information. However, the invention is by no means limited thereto.

In the embodiment of FIG. 1, it is assumed that a plurality of tasks 102a-d are available to be performed by a given worker, wherein each of these tasks are similar to tasks previously performed by that worker. (As used herein, a task is similar to another task, if both tasks require the same cognitive aptitude for successful completion). In addition, this worker has previously participated in the method of FIG. 1, in connection with his or her respective previous tasks. As a result of such previous activities, each of the tasks 102a-d is selected for an initial group of potential tasks, as shown by panel 102 of FIG. 1. Moreover, also as a result of his or her previous activities, the worker 102a-d has two metrics, comprising a Least Cognitive Score (LCS), and a Relative Score Cardinality (RSC). Each of these metrics pertains to the particular cognitive aptitude required for the specified task, and is defined more specifically hereinafter.

Referring further to FIG. 1, panel 104 shows that all workers are requested to play a cognitive aptitude measurement game. The game comprises an exercise that tests or monitors the extent to which the player possesses the particular cognitive aptitude, at the time the game is being played. Each game concludes by generating a representative game score (GS) for the worker playing the game. Usefully, the game may be played by the workers 102a-d on computers 104 a-d, respectively. The workers 102a-d receive respective scores GSₐ-GS_{d}, wherein each score is a measure of the particular cognitive aptitude of a worker at the time of play.

In an illustrative example of a game implemented on each of the computers 104 a-d, the cognitive aptitude required to perform the specified task is an ability to solve problems pertaining to spatial relationships. To measure this aptitude, a maze is presented to a worker on the display screen of his computer. The maze is randomly selected from a large number of different mazes which all have the same level of difficulty. Thus, a worker will not benefit from having played the game previously. At a start command, the worker must move an object on his screen from a maze entry point to a maze exit point, as quickly as possible. The resulting game score is a numerical value which indicates the time taken by the worker to complete this activity.

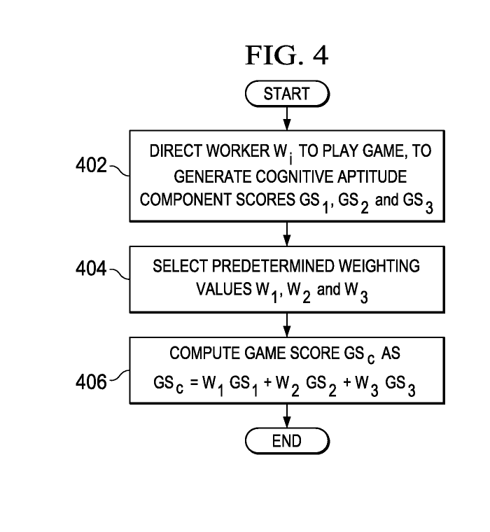

It is anticipated that in some embodiments of the invention, the specified task will require a worker to possess two or more different cognitive aptitudes, in order to successfully complete the task. An aptitude measurement game for tasks of this type, and computation of the game score, are discussed hereinafter in connection with FIG. 4.

At panel 106, the game score of each worker in the initial group is compared with the LCS of that worker. As stated above, each of the workers 102a-d had previously performed the specified task, or a task similar thereto. Also, each of the workers 102a-d had previously played the measurement game of panel 104, and received a game score for each game play event. The LCS, or Least Cognitive Score, of a given worker would then be the lowest of all previous game scores of the given worker, which were associated with the given worker successfully completing the specified or similar task. Thus, if the given worker had successfully performed the specified task three previous times, and had played the measurement game and received scores at each of those times, the lowest of the three game scores would be the current LCS of the given worker, for the step of panel 106 of FIG. 1. As a further example, if the given worker had successfully performed the specified task only once previously, the game score for that previous event would be the current LCS of the given worker.

Panel 106 illustrates further that the game score and LCS of each worker 102a-d is compared by determining whether or not the game score is greater than, or at least equal to, the LCS. If so, the worker is selected for a task performance candidate set. However, if the game score is less than the LCS, the worker is excluded from the set. Thus, the LCS of the worker, which indicates past performance in regard to the specified task, provides a useful metric for deciding whether or not to consider a worker further for recommending the task. If the worker's score from the game just played at step 104 is less than such metric, it is reasonable to assume that the worker's cognitive aptitude for the task is currently too low to ensure successful task completion. Accordingly, the worker is filtered out from further consideration, and is not selected for the task performance candidate set. Panel 106 shows, for example, that worker 102c was excluded from the candidate set.

It will be appreciated that by filtering workers as described above to provide the task performance candidate set, a worker who has had a pertinent cognitive aptitude significantly diminished, such as by an event of the type described above, will be excluded from the candidate set. Also, it will generally be desirable to minimize the period of time between playing the aptitude measurement game and performing the task. This would reduce the possibility of an event occurring during such time that diminishes the aptitude of the worker selected for task performance, but is not reflected by the worker's game score.

Referring further to FIG. 1, panel 108 shows the LCS and RSC of each member in the candidate set being used to select a particular worker, such as worker 102b, for recommending the specified task. Computation of the RSC, or Relative Score Cardinality, of a worker assumes that the worker has successfully performed the specified task, or tasks similar thereto, a number of times previously. It is also assumed that the worker has a game score, of the type described above in connection with panels 104 and 106, for each successful task performance. The RSC for that worker is then constructed, wherein the RSC comprises two numbers.

One of the numbers for the RSC is the total number of successful performances by the worker of the specified task and tasks similar thereto. The other number is the number of such tasks performed by the worker, wherein the corresponding game score was the LCS of the worker. As an example, if the RSC is (10:3), the worker performed the task successfully 10 times. Three of these performances occurred when the worker's game score was equal to the worker's LCS, which is regarded as the lowest score which that particular worker must have, in order to be reasonably sure that task performance will be successful. Thus, the RSC can provide a percentage value which defines how often the task was performed successfully for a game score of the worker's current LCS. For an RSC of (10:3), this percentage would be 30%.

In selecting the particular worker who will receive a recommendation to perform the specified task, it is useful to compare the LCS and RSC of each worker in the candidate set in accordance with a pre-specified recommendation rule. For example, the best candidate could be the worker who had the highest RSC percentage value, and a low LCS. Further recommendation rules for selecting a worker to perform the task are described hereinafter.

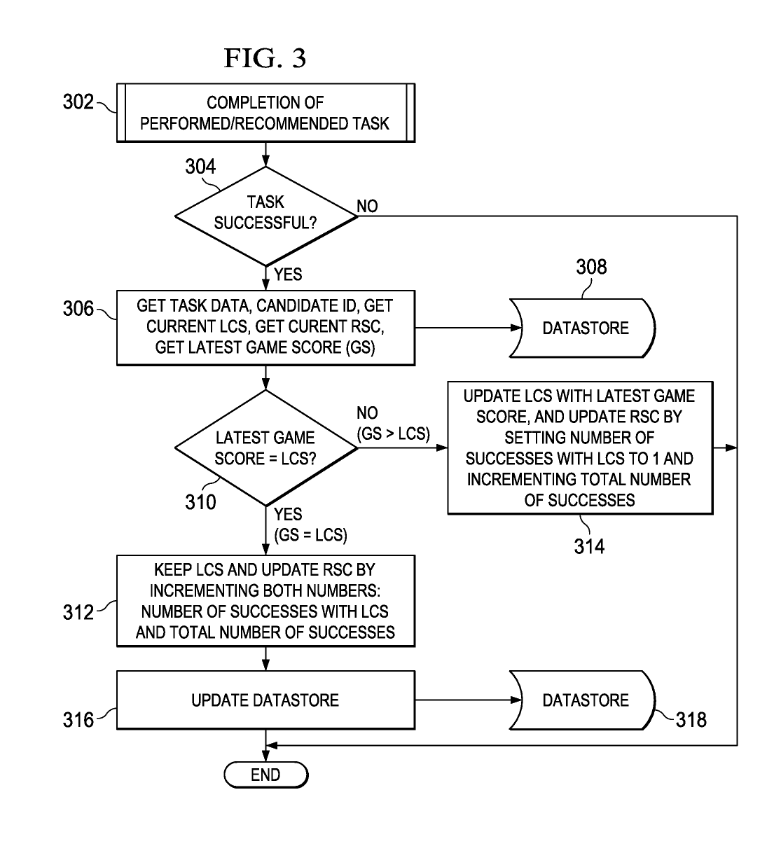

Panel 110 of FIG. 1 discloses that the LCS and RSC of the worker selected to perform the task are to be updated, after performance has been completed. This process is disclosed hereinafter in further detail, in connection with FIG. 3.

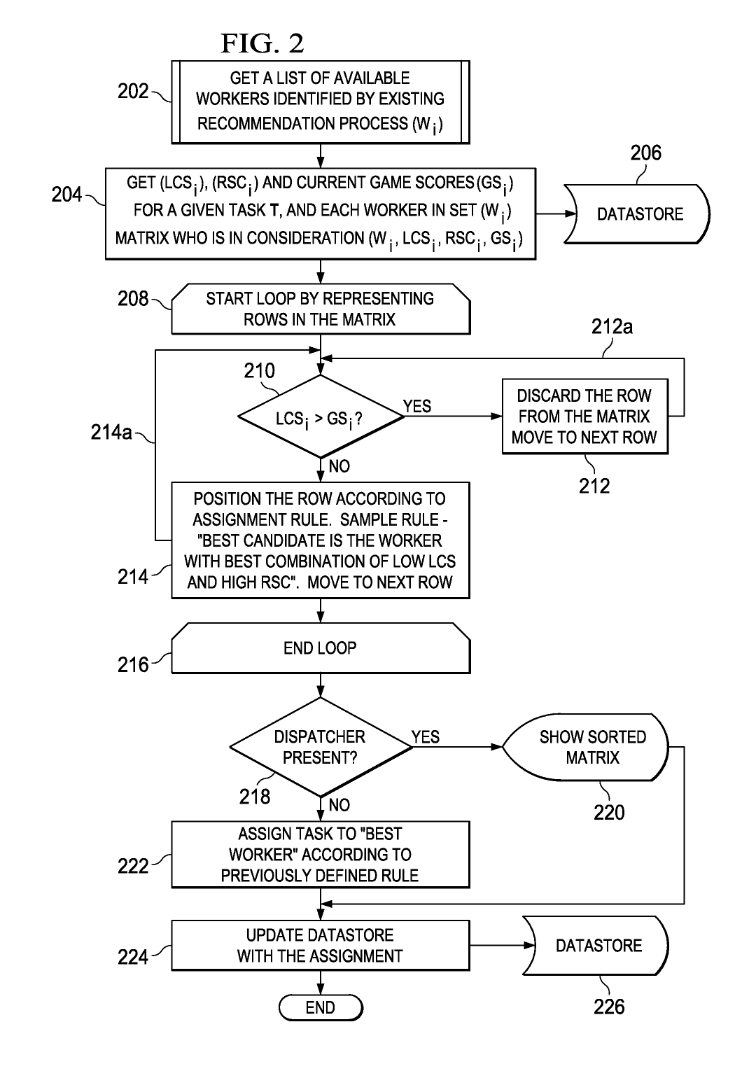

Referring to FIG. 2, there is shown a flowchart depicting steps for an algorithm that may be used to carry out steps or actions shown by panels 106-108 of FIG. 1. At step 202 of FIG. 2, available workers Wᵢ for carrying out a given or specified task T are initially identified, wherein one of them will finally be recommended the task. An existing recommendation process may be used for this initial identification. At step 204, information comprising a metric represented by the quadruple (Wᵢ, LCSᵢ, RSCᵢ, GSᵢ) is acquired from a data store 206, for each worker W₁. For a given worker Wᵢ, the LCSᵢ, RSCᵢ, and GSᵢ parameters respectively comprise the Least Cognitive Score, the Relative Score Cardinality, and the most recent Game Score for that worker.

The quadruples for each of the workers Wᵢ comprise the respective rows of a matrix. At step 208 of FIG. 2, a loop is started whereby information contained in each row of the matrix is considered sequentially, at decision step 210. More particularly, it is determined whether or not LCSᵢ is greater than GSᵢ for the worker Wᵢ. If the determination at step 210 is affirmative, the algorithm proceeds to step 212, which discards the row Wᵢ from the matrix. The worker Wᵢ is thereby filtered out from the overall method of selecting a worker to perform the task T. It is thus seen that steps 210 and 212 act collectively to perform the function of panel 106 of FIG. 1, by eliminating workers not qualified for the task performance candidate set. Step 212 also sends an output message 212a, which moves the next following row of the matrix to decision step 210.

If the determination at step 210 is negative, the algorithm proceeds to step 214. At this step, worker Wᵢ is positioned in an order with respect to other rows from step 210, in accordance with a recommendation rule. Step 214 also sends an output message 214a, which moves the next following row of the matrix to decision step 210. This process continues, until all the rows which pertain to workers qualified to be in the task performance candidate set have been moved to step 214.

It is anticipated that a number of different recommendation rules could be used at step 214 to determine the ordering of rows therein, and to thus select the worker who will finally be recommended task T. As one example of such recommendation rule, step 214 would consider the worker with the lowest LCS of those in the candidate set, and would then determine whether any other workers had LCS values that were within a prespecified narrow range of the lowest LCS. If so, the worker included in this range who had the highest RSC would be recommended the task T. Otherwise, the worker having the lowest LCS would be recommended the task.

Referring further to FIG. 2, it is seen that the looping process is ended at step 216, after each row in the matrix has been considered at either step 212 or 214. Thereafter, the algorithm proceeds to decision step 218, which determines whether a dispatcher or other administrator is present. If the decision is affirmative, the matrix, as it was ordered or sorted at step 214, is shown to the dispatcher at step 220. The dispatcher may then recommend the worker associated with the top row of the sorted matrix to perform the task, since such row was positioned in accordance with the recommendation rule. Alternatively, the dispatcher could consider the information provided by all of the sorted rows, and recommend the task to a worker associated with the top or a different row. The data store 226 is then updated with the recommendation, at step 224.

If it is determined at step 218 that a dispatcher is not present, the algorithm proceeds to step 222. This step automatically recommends the task to a worker, in accordance with the recommendation rule. Steps 224 and 226 are then carried out as described above, and the algorithm is ended. It is thus seen that steps 214-222 collectively perform the function of panel 108 of FIG. 1, by selecting a worker to recommend the specified task.

To further illustrate use of an embodiment of the invention to select appropriate workers to whom to recommend tasks, information contained in Tables 1 and 2, below, is considered. This information pertains to a group or pool of workers, identified as Bob, John and Tim, who are all qualified to perform each of several tasks T, referred to as A, B, and C. The tasks A, B and C are all similar to one another, in that each of these tasks requires the same particular cognitive aptitude or skill, in order to ensure successful task completion. Accordingly, an embodiment of the invention as described above is used to determine which of the workers Bob, John and Tim is best to perform each of the tasks A, B and C.

TABLE 1

| W | T | LCS | RSC |
|---|---|---|---|
| Bob | A | 3.5 | (23:101) |
| Bob | B | 2.9 | (3:50) |
| Bob | C | 2.5 | (1:43) |
| John | A | 3.0 | (11:19) |
| John | B | 3.7 | (9:49) |
| John | C | 3.2 | (27:104) |
| Tim | A | 4.1 | (44:131) |
| Tim | B | 4.0 | (24:89) |
| Tim | C | 3.3 | (2:68) |

TABLE 2

| T | W | GS | LCS | RSC |
|---|---|---|---|---|
| A | Bob | 4.1 | 3.5 | (23:101) |
| A | John | 3.5 | 3.0 | (11:19) |
| A | Tim | 4.0 | 4.1 | (44:131) |
| B | Bob | 4.1 | 2.9 | (3:50) |
| B | John | 3.5 | 3.7 | (9:49) |
| B | Tim | 4.0 | 4.0 | (24:89) |
| C | Bob | 4.1 | 2.5 | (1:43) |
| C | John | 3.5 | 3.2 | (27:104) |
| C | Tim | 4.0 | 3.3 | (2:68) |

Table 1 information is derived from past performances of tasks A, B and C by each of the workers Bob, John and Tim, and also from the game scores associated with those past performances. For example, Bob's LCS for task A is 3.5, and his RSC is (23:101). Thus, Bob carried out a task A successfully 101 times, and his game score for 23 of those times was equal to his LCS of 3.5. In like manner, John's LCS for task A is 3.0, and his RSC is (11:19). Tim's LCS for task A is 4.1, and his RSC is (44:131).

Table 2 contains the same information as Table 1, with the information reordered in relation to each of the tasks A, B, and C. In addition, Table 2 shows game scores (GS) for each of the workers, wherein each game score results from a recent measurement of the particular cognitive aptitude required to complete each of the tasks A, B and C. Thus, for each of the tasks, Bob has a game score of 4.1, John has a score of 3.0, and Tim has a score of 4.0. In one embodiment of the invention, each of the game scores would be acquired by having Bob, John and Tim each plays a cognitive aptitude measurement game, as described above, just before the tasks are to be recommended. In another embodiment, they would play the game on a periodic basis.

In recommending task A as described above in connection with FIG. 1, it would be determined at panel 106 that John and Tim each had a game score that was greater than their respective LCS values for task A. Accordingly, they would both be candidates to perform task A. However, Tim's game score is less than his LCS score for task A, so he would not be considered for task A.

In determining whether Bob or John should be recommended the task A, in accordance with one useful set of recommendation rules, it is noted that John has an RSC percentage value of 58%, whereas Bob has an RSC percentage of only 23%. Moreover, John has an LCS of 3.0 for task A, which is less than Bob's LCS of 3.5. This indicates that John can be successful at task A, even if his cognitive aptitude level is lower than Bob's level. Also, John has a lower game score than Bob. This results in Bob being qualified for more tasks than John. Bob could perform all the tasks A, B and C, but John couldn't perform task B, since his game score of 3.5 is less than his LCS of 3.7 for that task. Accordingly, in view of these considerations, it would be most useful to recommended task A to John.

In regard to task B, Bob and Tim could be selected as candidates for this task, but not John. Tim's RSC percentage is 27%, while Bob's RSC percentage is just 6%, at Bob's LCS of 2.9. Task B should therefore be recommended to Tim.

Bob, John and Tim could each be selected as a candidate to perform task C. However, John has an RSC percentage of 26%, whereas Bob and Tim both have very low RSC percentage values, of 0.02% and 0.03%, respectively. Task C should therefore be recommended to John.

Referring to FIG. 3, there is shown a flowchart for an algorithm that can be used to update LCS and RSC values, as indicated at panel 110 of FIG. 1. The algorithm commences at step 302, upon completion of a recommended task. The algorithm then proceeds to decision step 04, which determines whether task completion was successful or unsuccessful.

If the task was successful, the algorithm at step 306 retrieves certain information from data store 308. This information includes the identity of the worker who was recommended the task. Such information further includes the LCS, RSC and games score (GS) for that worker, which were respectively used in recommending the task to the worker, as described above in connection with FIGS. 1 and 2.

At decision step 310, information from step 306 is used to determine whether or not the game score of the worker is equal to his LCS. It will be appreciated that the only alternative to this is for his game score to be greater than his LCS. If the worker's game score had been less than his LCS, he would not have received a recommendation for the task.

Referring further to FIG. 3, if the decision at step 310 is affirmative, the algorithm proceeds to step 312. At this step it is determined to keep or continue the prior LCS as the LCS value for the worker going forward, since it is equal to his most recent game score. Also, both numbers included in the worker's RSC are properly incremented by one. As described above, these are the number of successes, respectively.

If the decision at step 310 is negative, the game score is greater than the prior LCS. Accordingly, the LCS is updated to the game score value at step 314. Also, the RSC is updated by setting the number of successful task performances at the new RSC to one. The total number of successes is incremented by one.

At step 316, results furnished by either step 312 or 314 are used to update data store 318. If it was determined at step 304 that task performance was not successful, the algorithm ends. Also, there are no updates to be made to either the LCS or the RSC of the worker.

Referring to FIG. 4, there is shown a flowchart depicting steps for a further embodiment of the invention. More particularly, FIG. 4 is directed to a situation wherein multiple different cognitive aptitudes are needed for the successful performance of a specified task. Accordingly, the game played by the workers should measure each of the multiple aptitudes, and provide a score for each measurement. These results would then be used to select the worker who would be given a recommendation for the task.

To address the situation of a number of cognitive aptitudes, a game would be constructed that included the same number of game activities, one activity for measuring each such aptitude. At step 402 of FIG. 4, each of the workers Wᵢ, such as workers 102a-102d described above, would be directed to play this game. If three different cognitive aptitudes were required for the task, the game would include three corresponding game activities, and each worker would receive three game scores GS₁, GS₂ and GS₃.

In order to most effectively use the three game scores, the relative importance of each cognitive aptitude in performing the task should be considered. For example, all the aptitudes could be of equal importance. Alternatively, one of them could be much more important than the other two. Accordingly, it would be useful to predetermine appropriate weighting values W₁, W₂ and W₃ for the respective cognitive aptitude scores. These weights are selected at step 404.

At step 406, a composite game score GS_{c} is computed as GS_{c}=W₁GS₁+W₂GS₂+W₃GS₃.

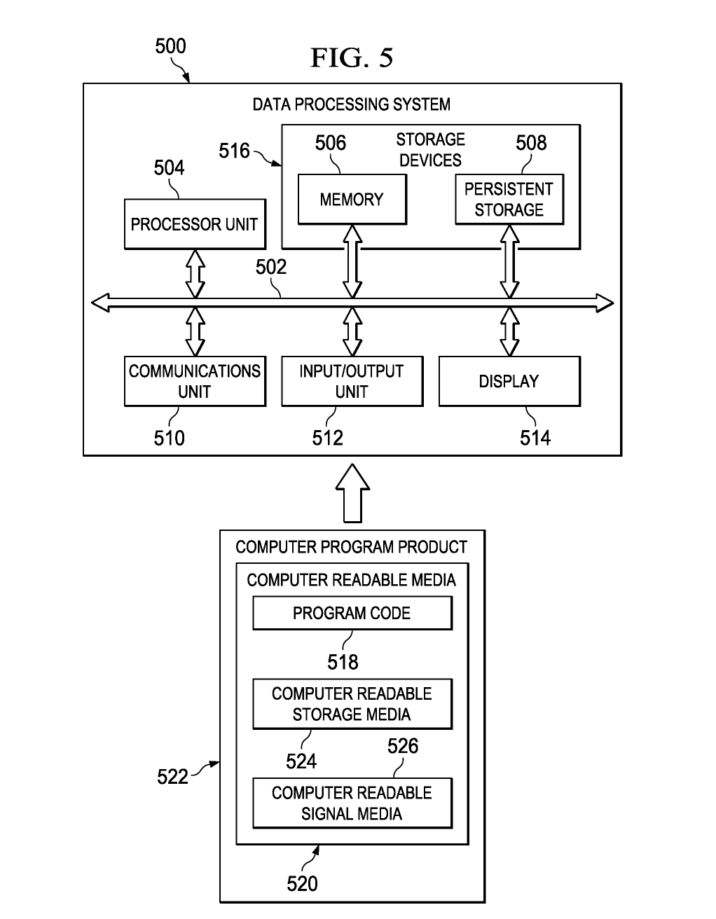

FIG. 5 depicts a block diagram of a data processing system in accordance with an illustrative embodiment. Data processing system 500 is an example of a computer, which may be used to implement one or more components of embodiments of the invention, and in which computer usable program code or instructions implementing the processes may be located for the illustrative embodiments. In this illustrative example, data processing system 500 includes communications fabric 502, which provides communications between processor unit 504, memory 506, persistent storage 508, communications unit 510, input/output (I/O) unit 512, and display 514.

Processor unit 504 serves to execute instructions for software that may be loaded into memory 506. Processor unit 504 may be a set of one or more processors or may be a multi-processor core, depending on the particular implementation. Further, processor unit 504 may be implemented using one or more heterogeneous processor systems, in which a main processor is present with secondary processors on a single chip. As another illustrative example, processor unit 504 may be a symmetric multi-processor system containing multiple processors of the same type.

Memory 506 and persistent storage 508 are examples of storage devices 516. A storage device is any piece of hardware that is capable of storing information, such as, for example, without limitation, data, program code in functional form, and/or other suitable information either on a temporary basis and/or a permanent basis. Memory 506, in these examples, may be, for example, a random access memory, or any other suitable volatile or non-volatile storage device. Persistent storage 508 may take various forms, depending on the particular implementation. For example, persistent storage 508 may contain one or more components or devices. For example, persistent storage 508 may be a hard drive, a flash memory, a rewritable optical disk, a rewritable magnetic tape, or some combination of the above. The media used by persistent storage 508 may be removable. For example, a removable hard drive may be used for persistent storage 508.

Communications unit 510, in these examples, provides for communication with other data processing systems or devices. In these examples, communications unit 510 is a network interface card. Communications unit 510 may provide communications through the use of either or both physical and wireless communications links.

Input/output unit 512 allows for the input and output of data with other devices that may be connected to data processing system 500. For example, input/output unit 512 may provide a connection for user input through a keyboard, a mouse, and/or some other suitable input device. Further, input/output unit 512 may send output to a printer. Display 514 provides a mechanism to display information to a user.

Instructions for the operating system, applications, and/or programs may be located in storage devices 516, which are in communication with processor unit 504 through communications fabric 502. In these illustrative examples, the instructions are in a functional form on persistent storage 508. These instructions may be loaded into memory 506 for execution by processor unit 504. The processes of the different embodiments may be performed by processor unit 504 using computer implemented instructions, which may be located in a memory, such as memory 506.

These instructions are referred to as program code, computer usable program code, or computer readable program code that may be read and executed by a processor in processor unit 504. The program code, in the different embodiments, may be embodied on different physical or computer readable storage media, such as memory 506 or persistent storage 508.

Program code 518 is located in a functional form on computer readable media 520 that is selectively removable and may be loaded onto or transferred to data processing system 500 for execution by processor unit 504. Program code 518 and computer readable media 520 form computer program product 522. In one example, computer readable media 520 may be computer readable storage media 524 or computer readable signal media 526. Computer readable storage media 524 may include, for example, an optical or magnetic disc that is inserted or placed into a drive or other device that is part of persistent storage 508 for transfer onto a storage device, such as a hard drive, that is part of persistent storage 508. Computer readable storage media 524 also may take the form of a persistent storage, such as a hard drive, a thumb drive, or a flash memory that is connected to data processing system 500. In some instances, computer readable storage media 524 may not be removable from data processing system 500.

Alternatively, program code 518 may be transferred to data processing system 500 using computer readable signal media 526. Computer readable signal media 526 may be, for example, a propagated data signal containing program code 518. For example, computer readable signal media 526 may be an electromagnetic signal, an optical signal, and/or any other suitable type of signal. These signals may be transmitted over communications links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communications links or wireless transmissions containing the program code.

In some illustrative embodiments, program code 518 may be downloaded over a network to persistent storage 508 from another device or data processing system through computer readable signal media 526 for use within data processing system 500. For instance, program code stored in a computer readable storage media in a server data processing system may be downloaded over a network from the server to data processing system 500. The data processing system providing program code 518 may be a server computer, a client computer, or some other device capable of storing and transmitting program code 518.

The different components illustrated for data processing system 500 are not meant to provide physical or architectural limitations to the manner in which different embodiments may be implemented. The different illustrative embodiments may be implemented in a data processing system including components in addition to and/or in place of those illustrated for data processing system 500. Other components shown in FIG. 5 can be varied from the illustrative examples shown. The different embodiments may be implemented using any hardware device or system capable of executing program code. As one example, data processing system 500 may include organic components integrated with inorganic components and/or may be comprised entirely of organic components excluding a human being. For example, a storage device may be comprised of an organic semiconductor.

As another example, a storage device in data processing system 500 is any hardware apparatus that may store data. Memory 506, persistent storage 508, and computer readable media 520 are examples of storage devices in a tangible form.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for recommending to a worker a specified task, wherein said method comprises the steps of:
selecting an initial set of workers maintained in a datastore, by one or more processors, wherein each worker has a least score value and an associated score cardinality, and the least score value and the score cardinality of a given worker are derived from one or more prior performances of the specified task by the given worker and are maintained in the datastore, wherein the least score value represents a lowest game score from an aptitude measurement game for tasks for a given worker and the score cardinality comprises a first value representative of task performance and a second value representative of game performance forming a pair of values, when expressed as a percentage, defines a number of times a task was performed successfully for a game score of the current least score of the given worker;
acquiring a game score associated with a game performance using a computer, for each worker of the initial set, wherein the game score of the given worker is a measurement of the level of a cognitive aptitude which the given worker possesses, and the cognitive aptitude is needed to perform the specified task, wherein the game score is stored in the datastore by the one or more processors;
placing one or more of the workers of the initial set into a task performance candidate set, by the one or more processors, wherein the given worker is placed into the task performance candidate set only if the game score of the given worker is no less than the least score value of the given worker; and
selectively processing, by the one or more processors using one or more predetermined recommendation rules, data provided collectively by the least score value and the score cardinality of each worker in the task performance candidate set, to select one of the workers in the candidate set to be recommended for the specified task.

2. The method of claim 1, wherein:
after performance of the specified task by said selected worker, the least score value and the score cardinality of said selected worker is updated selectively in the datastore by the one or more processors.

3. The method of claim 2, wherein:
the least score value and the score cardinality of said selected worker are respectively updated only if said selected worker has successfully performed the specified task, after being recommended for the specified task.

4. The method of claim 1, wherein:
the given worker acquires the game score by playing the game using the computer which requires said cognitive aptitude for successful game play, and the given worker receives the game score as a result of playing the game, which is a measurement of said cognitive aptitude.

5. The method of claim 4, wherein:
a plurality of cognitive aptitudes are needed to perform the specified task, and the game provides the game score which is a measurement of each of the plurality of cognitive aptitudes of a worker who has played the game.

6. The method of claim 1, wherein:
the given worker has the game score for each successful prior performance of the specified task by the given worker, and the least score value of the given worker is a Least Cognitive Score (LCS) that comprises the lowest of said prior performance game scores.

7. The method of claim 6, wherein:
the score cardinality of the given worker is a Relative Score Cardinality (RSC), wherein the first value representative of task performance being the total number of previous successful performances of the specified task by the given worker, and the second value representative of game performance being the number of said previous performances for which the game score was equal to the LCS of the given worker.

8. The method of claim 1, wherein placing one or more of the workers of the initial set into a task performance candidate set further comprises:
constructing a matrix that comprises a row for each worker in the initial set of workers, wherein the row for the given worker comprises a quadruple that includes the game score, the least score value, the score cardinality, and an identity of the given worker.

9. The method of claim 8, further comprising:
considering each quadruple of the matrix, to determine whether the game score of a given worker is no less than the least score value of the given worker.

10. The method of claim 1, wherein selectively processing, by the one or more processors using one or more predetermined recommendation rules further comprises:
using a pre-specified best person recommendation rule to select the worker for whom to recommend the specified task, wherein the best person recommendation rule employs information comprising the game score, the least score value and the score cardinality of each worker in the candidate set.

11. A computer program product for selecting a worker to perform a specified task, having instructions stored in a non-transitory computer recordable data storage medium for execution by one or more processors, wherein said computer program product comprises:
instructions for selecting an initial set of workers maintained in a datastore, wherein each worker has a least score value and an associated score cardinality, and the least score value and the score cardinality of a given worker are derived from one or more prior performances of the specified task by the given worker and are maintained in the datastore, wherein the least score value represents a lowest game score from an aptitude measurement game for tasks for a given worker and the score cardinality comprises a first value representative of task performance and a second value representative of game performance forming a pair of values when expressed as a percentage defines a number of times a task was performed successfully for a game score of the current least score of the given worker;
instructions for acquiring a game score associated with a game performance using a computer for each worker of the initial set, wherein the game score of the given worker is a measurement of the level of a cognitive aptitude which the given worker possesses, and the cognitive aptitude is needed to perform the specified task, wherein the game score is stored in the datastore;
instructions for placing one or more of the workers of the initial set into a task performance candidate set, wherein the given worker is placed into the task performance candidate set only if the game score of the given worker is no less than the least score value of the given worker; and
instructions for selectively processing using one or more predetermined recommendation rules data provided collectively by the least score value and the score cardinality of each worker in the task performance candidate set, to select one of the workers in the candidate set to be recommended for the specified task.

12. The computer program product of claim 11, further comprising:
instructions for selectively updating, after performance of the specified task by said selected worker, the least score value and the score cardinality of said selected worker in the datastore.

13. The computer program product of claim 11, wherein:
the given worker acquires the game score by playing the game using the computer which requires said cognitive aptitude for successful game play, and the given worker receives the game score as a result of playing the game, which is a measurement of said cognitive aptitude.

14. The computer program product of claim 11, wherein instructions for placing one or more of the workers of the initial set into a task performance candidate set further comprises:
instructions for constructing a matrix that comprises a row for each worker in the initial set of workers, wherein the row for the given worker comprises a quadruple that includes the game score, the least score value, the score cardinality, and an identity of the given worker, and
instructions for using the matrix in determining whether the game score of the given worker is no less than the least score value of the given worker wherein the instructions are stored in the non-transitory computer recordable data storage medium.

15. The computer program product of claim 11, wherein instructions for selectively processing using one or more predetermined recommendation rules further comprises:
instructions for using a pre-specified best person recommendation rule to select the worker for recommendation of the specified task, wherein the best person recommendation rule employs information comprising the game score, the least score value and the score cardinality of each worker in the candidate set.

16. Apparatus for recommending to a worker a specified task, the apparatus comprises:
a communications fabric;
a memory connected to the communications fabric, wherein the memory contains instructions stored in the memory;
one or more processors connected to the communications fabric, wherein the one or more processors execute the instructions stored in the memory to direct the apparatus to:
select an initial set of workers, maintained in a datastore, wherein each worker has a least score value and an associated score cardinality, and the least score value and the score cardinality of a given worker are derived from one or more prior performances of the specified task by the given worker and are maintained in the datastore, wherein the least score value represents a lowest game score from an aptitude measurement game for tasks for a given worker and the score cardinality comprises a first value representative of task performance and a second value representative of game performance forming a pair of values when expressed as a percentage defines a number of times a task was performed successfully for a game score of the current least score of the given worker;
acquire a game score associated with a game performance using a computer for each worker of the initial set, wherein the game score of the given worker is a measurement of the level of a cognitive aptitude which the given worker possesses, and the cognitive aptitude is needed to perform the specified task, wherein the game score is stored in the datastore by the one or more processors;
place one or more of the workers of the initial set into a task performance candidate set, wherein the given worker is placed into the task performance candidate set only if the game score of the given worker is no less than the least score value of the given worker; and
selectively process using one or more predetermined recommendation rules, data provided collectively by the least score value and the score cardinality of each worker in the task performance candidate set, to select one of the workers in the task performance candidate set to be recommended for the specified task.

17. The apparatus of claim 16, wherein the one or more processors further executes the instructions stored in the memory to direct the apparatus to:
selectively update the least score value and the score cardinality of said selected worker in the datastore after performance of the specified task by said selected worker.

18. The apparatus of claim 16, wherein:
the given worker acquires the game score by playing the game using the computer which requires said cognitive aptitude for successful game play, and the given worker receives the game score as a result of playing the game, which is a measurement of said cognitive aptitude.

19. The apparatus of claim 16, wherein the one or more processors further executes the instructions stored in the memory to direct the apparatus to:
construct a matrix that comprises a row for each worker in the initial set of workers, wherein the row for a given worker comprises a quadruple that includes the game score, the least score value, the score cardinality, and an identity of the given worker.

20. The apparatus of claim 16, wherein the one or more processors further executes the instructions stored in the memory to direct the apparatus to:
use a pre-specified best person recommendation rule to select the worker to whom to recommend the specified task, wherein the best person recommendation rule employs information comprising the game score, the least score value and the score cardinality of each worker in the candidate set.
